(19) United States
(12) Patent Application Publication
(10) Pub. No.: US 2008/0055317 A1
(43) Pub. Date: Mar. 6, 2008

(54) Synchronization and coordination of animations

(75) Inventors: Glenn Abel, La Jolla, CA (US); Ricardo Cook, Chula Vista, CA (US); Andrew J. Wolpe, La Jolla, CA (US)

Correspondence Address: ALTON W. PAYNE, 5508 GRAND LAKE, HOUSTON, TX, 77081, US

(73) Assignee: Magnifi Group Inc.

(21) Appl. No.: 11/512,995

(22) Filed: Aug. 30, 2006

(51) Int. Cl. G06T 13/00

(52) U.S. Cl. 345/473

(57) ABSTRACT

A method of synchronizing and controlling a source animation with a target animation is provided. In another embodiment of the present invention a method of synchronizing and controlling a source animation with a plurality of target animations with all the animations on the same web page is provided. In yet another embodiment of the present invention a method of synchronizing and controlling a source animation in association with a parent web page with a target animation in association with a child web page where the source animation is in operative association with the target animation is provided. The synchronization and coordination of the target animation with the source animation accurately reflects the change or changes in the source animation in the target animation and thereby enhances the proficiency and experience of the user.

### FIELD OF THE INVENTION

The present invention relates generally to the synchronization and coordination of a plurality of animations, two-dimensional, three-dimensional or multi-dimensional. More particularly, the present invention relates to a channel and method in which a set of different animations communicate and coordinate with each other to enhance the user's proficiency and experience. In a preferred embodiment, the present invention relates to the Viewpoint Media Player (VMP) and enhancing the user interactivity from the original scope intended by Viewpoint, and extends to any media player for the synchronization and coordination of a plurality of animations.

### BACKGROUND OF THE INVENTION

The evolution of Web content has evolved from pure text content, to images (static and animated), audio and video. For the most part, multimedia has been a substantial addition to any website, as it provides an option for richer content and visual design. Although the Web provides support for audio and video (i.e., movies, streaming real-time feedback or animation), it doesn't necessarily represent the best medium to replicate these formats compared to other platforms, such as a CD or DVD player. The reason the Web has problems supporting audio and video is that the file size of the multimedia components requires a great amount of time to download or stream. By publishing files for a complete download, the viewer needs to wait for the file to download in its entirety before it displays. The other method, streaming, allows the contents to display and play when the first segment is made available, while in the background the rest of the file is being downloaded. Even with these methods for large file size video, many considerations need to be taken into account when including video files on a Web site.

Animations, two-dimensional and three-dimensional, are considered to be a type of video. Any two-dimensional animation file size is considerably small when compared to a three-dimensional animation file. The difference in the magnitude of the file sizes is due to additional features that can be, and typically are, included as part of a three-dimensional animation. Such additional features include effects such as, shadows, reflections, waves, etc., as well as surfaces, textures, and other animation characteristics. Because of its visual benefits, three-dimensional animation has been an asset for almost any market that requires demonstrating a product, procedure, location, or any other element of interest. In most cases, an animation is enough to provide the necessary information but in product procedures, specifically detailed-oriented procedures, such as by way of example, a medical device, a medical or engineering procedure, and the application of an engineering tool. There are two characteristics which do not make this type of animation the best solution for detail-oriented procedures: file size and lack of interactivity. The files are large and the lack of interactivity is restrictive.

In a traditional three-dimensional animation the file size is inherent to the format. There are no solutions to work around this issue. The problem does not arise when the animation is distributed through CD, DVD or even viewed locally from the end-user's computer. However, as animations become part of a company's marketing or training solution, internet distribution is inevitable; and this is when file size becomes a problematic issue.

In addition, traditional three-dimensional animation provides a pre-set camera angle, giving the viewer no other choice but to see a single interpretation of the procedure, device or associated application. When animations are detail-oriented, it is important for the viewer to be able to manipulate and interact with the animation. By giving complete control to the user, an animation would be more appreciated and useful if it was accessible from different angles, positions and distances.

Moving from traditional three-dimensional animations to a format that addresses two critical issues, file size and interactivity, is the main reason that MAG¹⁰ technology is being implemented on animations designed for the Viewpoint Media Player (VMP) or similar devices. The file size is reduced drastically, so internet distribution is reasonable, and the user is able to interact with the animation. Unfortunately, as with any solution, there will always be new challenges to overcome. In their native format, all animations designed for the VMP or similar devices have limited functionality. Basic interactivity can be added, such as for example a way for the user to stop, play or restart the animation. Ideally, for detail-oriented procedures, there should be a method for the user to be able to view the procedure via multiple perspectives which enhances the viewer's experience. MAG¹⁰ technology provides a solution to view the procedure via multiple perspectives which enhances the viewer's experience.

The Internet and the World Wide Web are rapidly expanding, with businesses and individuals using their own Web pages. This has created a demand for richer Web page capabilities especially in the area of coordinated presentations and control of multimedia events, including being able to easily synchronize the execution of a plurality of multimedia events over a period of time by coordinating multimedia presentations. Because not all Web page owners are sophisticated computer users, the design and programming of Web pages must remain simple. Further, the synchronizing of multimedia events within a Web page should not require complicated or lengthy user programs. Instead, implementing and controlling a Web page should be intuitive and “user-friendly” while still providing sophisticated capabilities, such as synchronizing and coordinating animations during a sequence.

Web pages are composed of various multimedia elements, controls, and applets as defined by the Hypertext Markup Language (HTML) for a given Web page. Multimedia can be characterized as some combination of visual media, audio media and time. Multimedia is an open environment, with timing being the common thread across all multimedia events. Multimedia experiences, such as the movement of physical models, graphics and the playing of sound, require coordinated execution of these events from different perspectives. For instance, the playing of a medical procedure or event can be viewed from various perspectives to enable the viewer to fully appreciate the procedure or event. For example, the presentation of a medical procedure or something as simple as viewing a broken wrist can be much better appreciated if viewed from various perspectives simultaneously. In the case of the broken wrist, additional fractures may not be viewable from a single perspective.

Providing synchronized multimedia experiences is complicated because timing control information is not inherent in the content of an HTML document. Past attempts at providing such synchronization and coordination of activities within a Web page have basically take on one of several forms, such as for example, (1) external programs and (2) lengthy, complicated scripts or programs. These solutions generally are non-user-friendly, require additional hardware resources, software resources and/or expenses, and do not provide true synchronization of events. Additionally, other approaches have not allowed synchronization and coordination between or among animations.

External multimedia control programs, such as Director, by Macromedia, can be expensive, and do not allow the synchronization and coordination between or among animations by editing the HTML code. Rather, any changes and additions to the animations must be made using the external program itself. Furthermore, the timing mechanism of some of these external programs are based on “frames” of time rather than directly on a time scale. A frame corresponds to a duration of time during which a set of defined activities are to be performed. Frames provide a method to sequentially perform sets of activities where there is some timing relationship based on frame rates and the time required for the sets of activities within the frame to be performed. However, individual events are not specified to be executed at a particular time (e.g., at time t=10.000 seconds), rather to execute within a frame (e.g., in frame 2).

Generally, animations created for a media player, such as, for example, the Viewpoint Media Player (VMP), have a limited functionality. Having limited functionality means, by way of example and without limitation, restrictions in resetting the animation, playing an animation through its entire course, control of the animation, and restrictions in the synchronization and coordination of a plurality of animations. Although media players, such as by way of example, Viewpoint Technology (VET), provide a rudimentary process to accomplish specified functionality, the lack of functionality has proven to be a drawback in an applicable project's development cycle.

It is, therefore, a feature of the present invention to provide a channel and method in which a set of different animations communicate and coordinate with each other to provide the synchronization of the animations to thereby enhance the user's proficiency and experience. The present invention works in conjunction with animations created for media players generally, and specifically for the Viewpoint Media Player (VMP). The present invention provides an innovative channel and method to enhance the user's interactivity with the animations.

Additional features and advantages of the invention will be set forth in part in the description which follows, and in part will become apparent from the description, or may be learned by practice of the invention. The features and advantages of the invention may be realized by means of the combinations and steps particularly pointed out in the appended claims.

### SUMMARY OF THE INVENTION

To achieve the foregoing objects, features, and advantages and in accordance with the purpose of the invention as embodied and broadly described herein, a channel and method in which a set of different animations communicate and coordinate with each other to provide the synchronization of the animations to thereby enhance the user's proficiency and experience is provided.

The present invention adds a user interactivity level to three-dimensional animations designed for media viewers through manipulation of one or several three-dimensional animations. Further, visual feedbacks are provided to the user by updating or changing the configuration on other co-existent three-dimensional animations within the same project.

Many different configurations are available for adoption and use with respect to the present invention. By way of example, the following configurations are available:
(1) One animation controlling one or several animations within one web page.
(2) Several animations having the capability of controlling several animations within one web page.
(3) One animation controlling a second animation in a child web page.

The synchronization and coordination accomplished by the present invention requires at least two animations. At least one of the animations is designated as a source animation. The remainder of the animations is designated as the target animations. The interface may also be targeted to reflect any of these changes in order to aid the visual reference on any values that should be provided to the user (i.e. angles, distance, position, etc.). Such changes, by way of example but without limitation, comprise buttons, labels, images or any visual media that is part of a Web interface. More particularly, if a user drags an object to the left of the screen, a label on the interface can be changed to read “LEFT.” And, when the user drags the object to the right of the screen, a label on the interface can be changed to read “RIGHT.” Thus, if the example were to view the human heart, markers or labels can be arranged adjacent to the heart to indicate the angle at which the heart is being viewed. As the user moves or rotates the heart, the markers or labels change to reflect the orientation of the heart.

The source animation contains added functionality which is defined as an interactor. The interactor is used to report specific changes created by the user. The changes created by the user can include, by way of example, rotating the scene, zooming in or out of the center of the scene or panning the scene, selecting specific parts or components within the animation such as dragging, clicking, selecting a hotspot, rotating, or zooming. Once the user interacts with the three-dimensional animation and any of the changes are created then a series of functions will determine the next action to take in the target animations. Pursuant to the control defined by the functions, the actions will indicate if the target animations will be modified to be coordinated with the same values in order to be synchronized with or mimic the source animation's movement, or, if a different movement needs to be created. Each animation's requirements will determine what actions will take place.

In one embodiment, a method of synchronizing and controlling a source animation with a target animation is provided. The method of synchronizing and controlling a source animation with a target animation comprises the steps of making a change in the source animation, and evaluating the characteristics of the change via an interactor function for generating a change message. The change message is sent for evaluation. The change message is evaluated to determine the effects on the target animation because of the change in the source animation. Calculating the changes to be made in the target animation, if any, based upon the change message. Determining if the calculated changes to the target animation require changes in the target animation. And, synchronize and coordinate the target animation with the source animation, if appropriate, to accurately reflect the changes in the source animation in the target animation to enhance the user's proficiency and experience.

In another embodiment of the present invention a method of synchronizing and controlling a source animation with a plurality of target animations with all the animations on the same web page is provided. The method of synchronizing and controlling a source animation with a plurality of target animations with all the animations on the same web page comprises the steps of making a change in the source animation, communicating the change in the source animation with a listener, capturing and determining the message parameters, transferring the captured message parameters to a processor, processing the captured message parameters, transferring the processed signals to the respective target animations, altering, as appropriate, the target animations so as to synchronize and coordinate the changes made in the source animation with what is viewed in the target animations.

In yet another embodiment of the present invention a method of synchronizing and controlling a source animation in association with a parent web page with a target animation in association with a child web page where the source animation is in operative association with the target animation is provided. The method comprises the steps of initiating a change in the source animation, communicating the change in the source animation with a listener associated with the same web page, capturing and determining the message parameters, transferring the captured message parameters to a processor associated with the target web page, processing the captured message parameters, transferring the processed signals to the respective target animation, and altering as appropriate the target animation so as to synchronize and coordinate the changes made in the source animation with what is viewed in the target animation.

### BRIEF DESCRIPTION OF THE DRAWINGS

The accompanying drawings which are incorporated in and constitute a part of the specification, illustrate a preferred embodiment of the invention and together with the general description of the invention given above and the detailed description of the preferred embodiment given below, serve to explain the principles of the invention.

FIG. 1 is a flowchart illustrating an overview of the method of the present invention for a source animation in association with a target animation.

FIG. 2 is a flowchart of the method of the present invention illustrating one source animation in association with “n” target animations.

FIG. 3 is a flowchart of the method of the present invention illustrating multiple source animations acting as either the source animation or the target animation.

FIG. 4 is a flowchart of the method of the present invention illustrating a source animation in association with a parent web page acting on a target animation in association with a child web page.

FIG. 5 is a flowchart of a portion of the present invention illustrating the flow of information from the source animation.

FIG. 6 is a flowchart of a portion of the present invention illustrating a preferred group of components embodied in the present invention.

FIG. 7 is a flowchart of a portion of the present invention illustrating a listener component associated with the present invention.

FIG. 8 is a flowchart of a portion of the present invention illustrating a processor component associated with the present invention.

FIG. 9 is a flowchart of a method of the present invention illustrating the manipulation of one or more objects in a set of animations through a user interface associated with the present invention.

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF THE PREFERRED EMBODIMENTS

Reference will now be made in detail to the present preferred embodiments of the invention as described in the accompanying drawings.

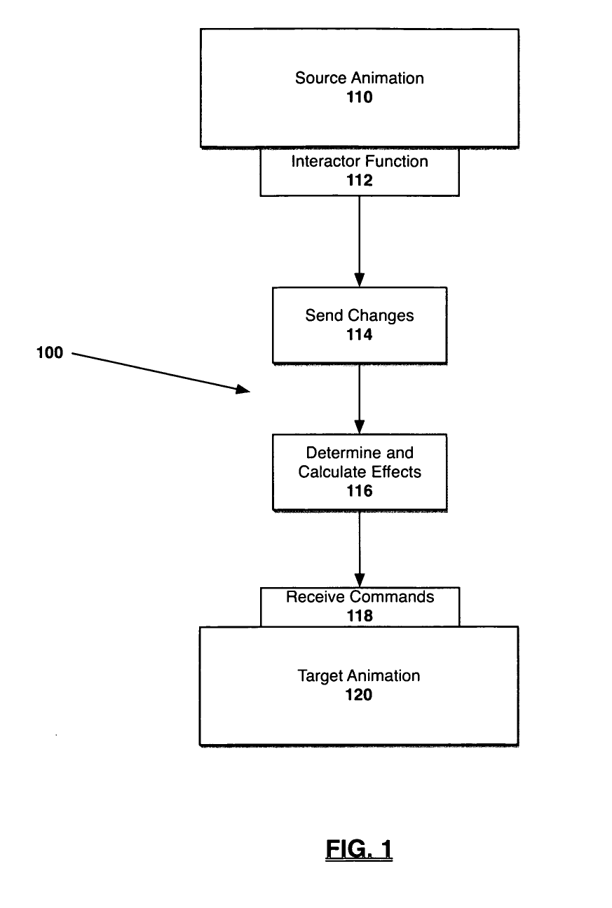

FIG. 1 is a flowchart illustrating an overview of the method 100 of the present invention for a source animation 110 in association with a target animation 120. The method 100 of synchronizing and controlling a source animation 110 with a target animation 120 comprises the steps of making a change in the source animation 110, determining the characteristics of the change via an interactor function 112, sending the change 114 to the target animation 120, determining and calculating the effects 116 of the change in the source animation 110 on the target animation 120, receiving the commands for evaluation 118 by the target animation 120, and, synchronizing and coordinating the target animation 120 with the source animation 110.

FIG. 1 illustrates the method of synchronizing and controlling a source animation with a target animation comprising the steps of making a change in the source animation, and evaluating the characteristics of the change via an interactor function for generating a change message. Then, the change message is sent for evaluation. The change message is evaluated to determine the effects on the target animation because of the change in the source animation. Thereafter, the changes to be made in the target animation, if any, are calculated based upon the change message. Then, a determination is made of whether the calculated changes to the target animation require changes in the target animation. And, if appropriate, the target animation is synchronized and coordinated with the source animation, to accurately reflect the changes that were made in the source animation in the target animation for enhancing the user's proficiency and experience.

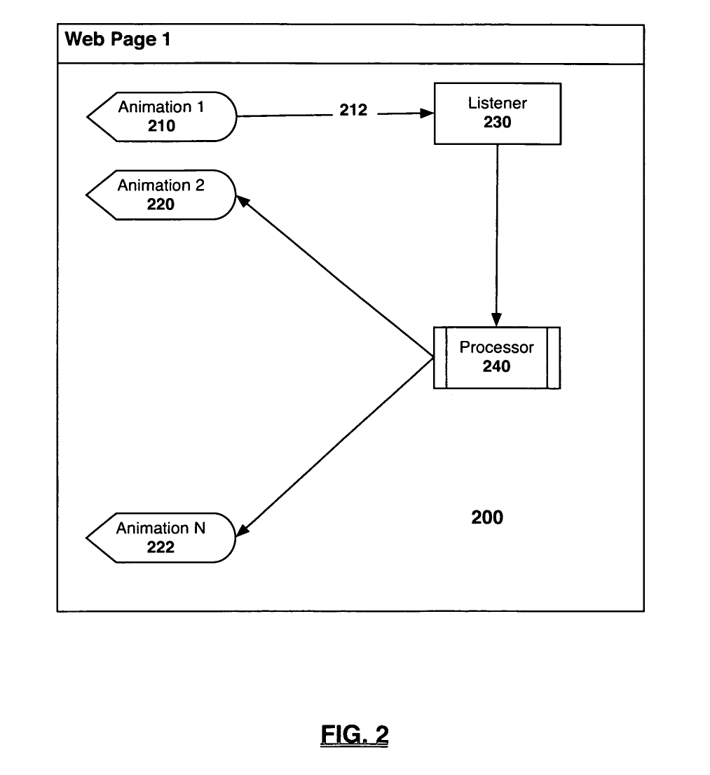

FIG. 2 is a flowchart of the method of synchronizing and controlling a source animation 210 with a plurality of target animations 220, 222 for the present invention. FIG. 2 illustrates one source animation 210 in association with “n” target animations 220, 222 with all the animations 210, 220, 222 on the same web page 200. After a change in the source animation 210, the source animation 210 communicates with the listener 230 by sending a message 212. The listener 230 captures and determines the message 212 parameters. The captured message parameters are transferred to the processor 240 for processing. The processed signals are transferred to the respective target animations 220, 222. The target animations 220, 222 are altered to synchronize and coordinate the changes made in the source animation 210 with what is viewed in the target animations 220, 222.

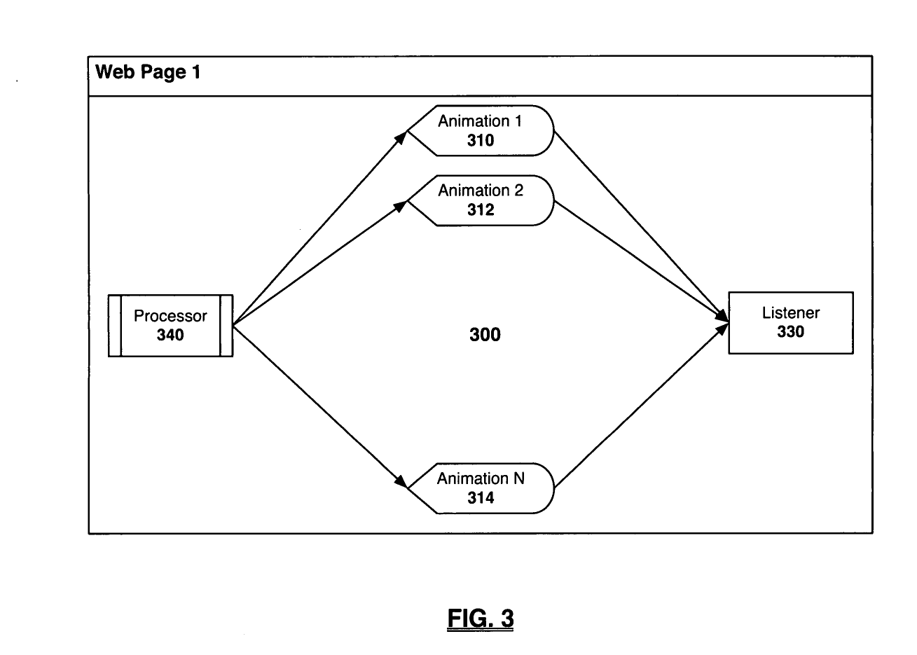

FIG. 3 is a flowchart of the method of the present invention with multiple or “n” source animations 310, 312, 314 on the same web page 300 with each source animation 310, 312, 314 acting as either a source animation 310, 312, 314 or a target animation 310, 312, 314.

By way of example, in FIG. 3, a change is made in the first animation 310. After a change therein, the first source animation 310 communicates with the listener 330 by sending a message. The listener 330 captures and determines the message parameters. The captured message parameters are transferred to the processor 340 for processing. The processed signals are transferred to the respective target animations 312, 314. The respective target animations 312, 314 are altered to synchronize and coordinate the changes made in the first animation 310 with what is viewed in the other target animations 312, 314.

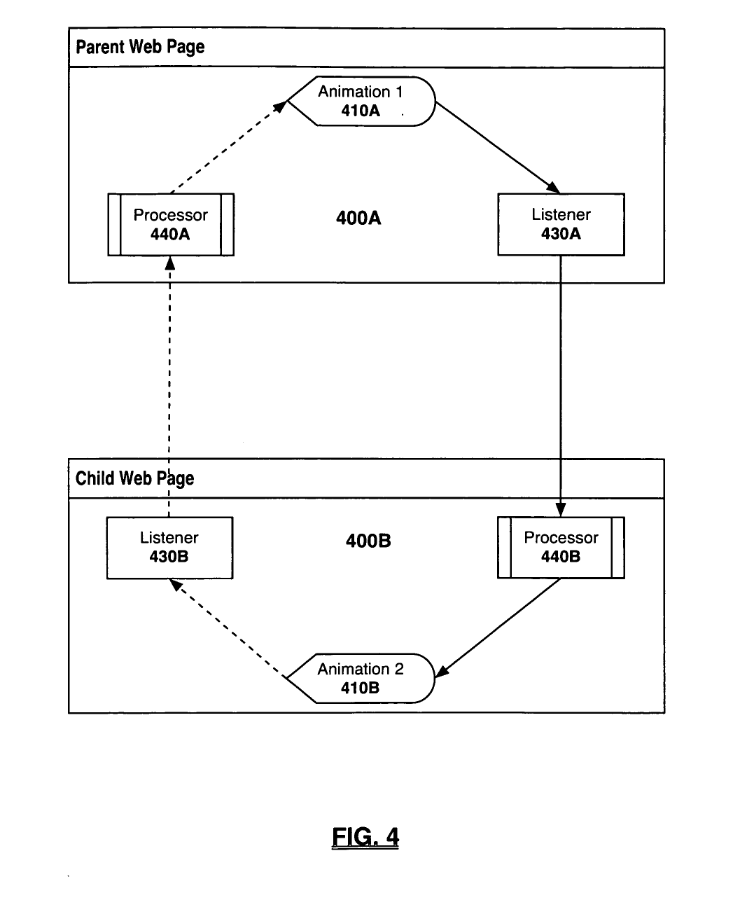

FIG. 4 is a flowchart of the method of the present invention illustrating a source animation 410A in association with a parent web page 400A acting on a target animation 410B in association with a child web page 400B. FIG. 4 illustrates a source animation 410A in operative association with a target animation 410B with the latter animation 410B being in a different, but related, web page such as for example, a child web page 400B. After a change in the source animation 410A, the source animation 410A communicates with a listener 430A associated with the same web page 400A by sending a message. The listener 430A captures and determines the message parameters. The captured message parameters are transferred to a processor 440B associated with the related child web page 400B for processing. The processed signals are transferred to the respective target animation 410B in the related child web page 400B. The target animation 410B, if appropriate, is altered to synchronize and coordinate the changes made in the source animation 410A with what is viewed in the target animation 410B in the child web page 400B.

Also illustrated in FIG. 4 is a reverse sequence. The reverse sequence is initiated from the related child web page 400B and is communicated to the parent web page 400A. Thus, any change in the animation 410B in the child web page 400B is synchronized and coordinated with what is viewed in the animation 410A in the parent web page 400A. After a change in the animation 410B, the animation 410B communicates with a listener 430B associated with the same web page 400B by sending a message. The listener 430B captures and determines the message parameters. The captured message parameters are transferred to a processor 440A associated with the related web page 400A for processing. The processed signals are transferred to the respective target animation 410A in the related web page 400A. The target animation 410A, if appropriate, is altered to synchronize and coordinate the changes made in the source animation 410B with what is viewed in the target animation 410A in the web page 400A.

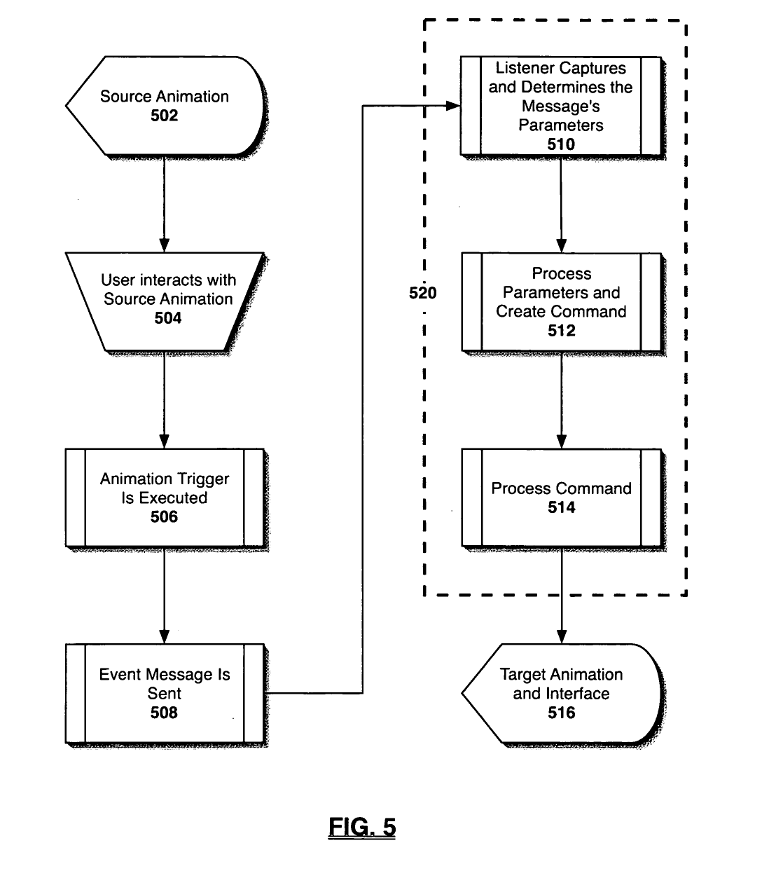

FIG. 5 is a flowchart of one embodiment of the method of the present invention illustrating the flow of information from a source animation 502. FIG. 5 illustrates the flow of information from the source animation 502 to the target animation 516. Information originally resides in association with the source animation 502. The source animation 502 is changed by a user interacting 504 with the source animation 502. When the user interacts 504 with the source animation 502, an animation trigger is executed 506. When the animation trigger 506 is executed, then the event message 508 is sent. The sent event message 508 is received by the listener 510. The listener 510 captures and determines the parameters of the massage. The message parameters are processed and a corresponding command is created 512. The created command is processed 514. The processed command is sent to the target animation 516 for implementation such that the target animation is synchronized and coordinated with the source animation, to accurately reflect the changes that were made in the source animation in the target animation for enhancing the proficiency and experience of the user. The execution of the animation trigger 506 is the same as the interactor 112 as illustrated and discussed in FIG. 1. Although not required by someone skilled in the art to which the invention pertains, in a preferred embodiment, Java Script is used to implement the steps of receiving the event message 508 by the listener 510, the listener 510 capturing and determining the parameters of the massage, the message parameters being processed and a corresponding command being created 512, such that the created command is processed 514, and the processed command is sent to the target animation 516 for implementation.

The synchronization between animations illustrated in FIG. 5 requires at least two animations: a source and a target. These animations may be in the same web page as illustrated in FIGS. 2 and 3 or in parent-child web pages as illustrated in FIG. 4. Once a user has interacted with the source animation, an event is triggered by the interaction. Not all actions created by the user are necessarily tracked, but only those determined by a specific project. The triggered event results in a message, which needs to be interpreted to determine the following:
the source of the event; multiple sources may exist in a project,
the target or targets of the event, and
the action to be implemented.

### A series of messages are formatted, sent and processed by the target animations and its associated interface.

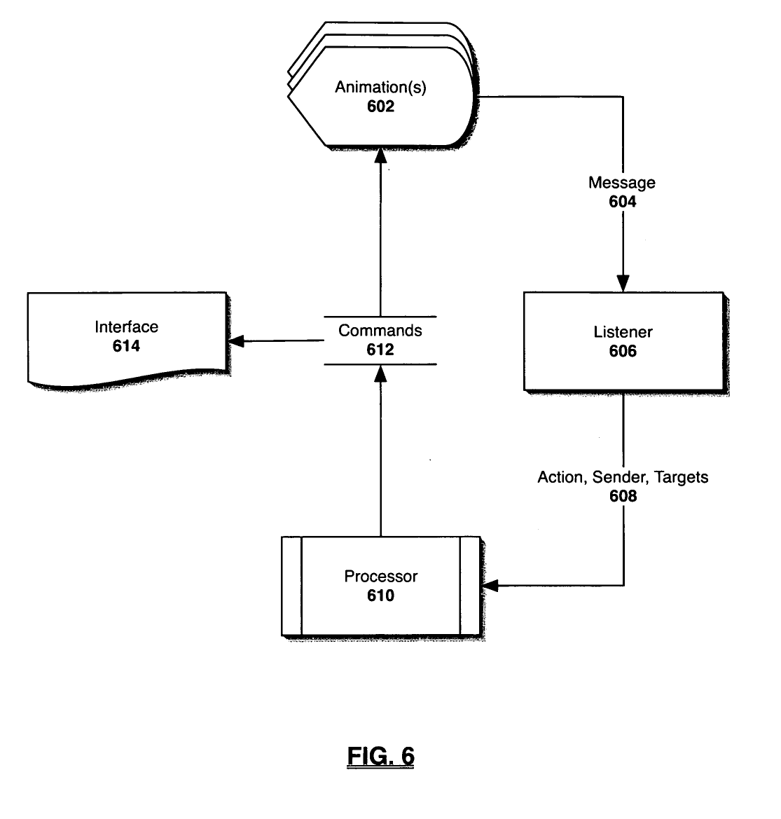

FIG. 6 is a flowchart illustrating a preferred group of components 600 embodied in the present invention. Preferably, the components 600 are a plurality of animations 602, a message 604, a listener 606, information 608 comprising action, sender, and target data, a processor 610, a command 612 and an interface 614. The message 604 is sent from an animation 602 to the listener 606. The listener 606 sends information 608 comprising action, sender, and target data to the processor 610. The processor 610 sends commands 612 to the interface 614 and to the corresponding animation 602.

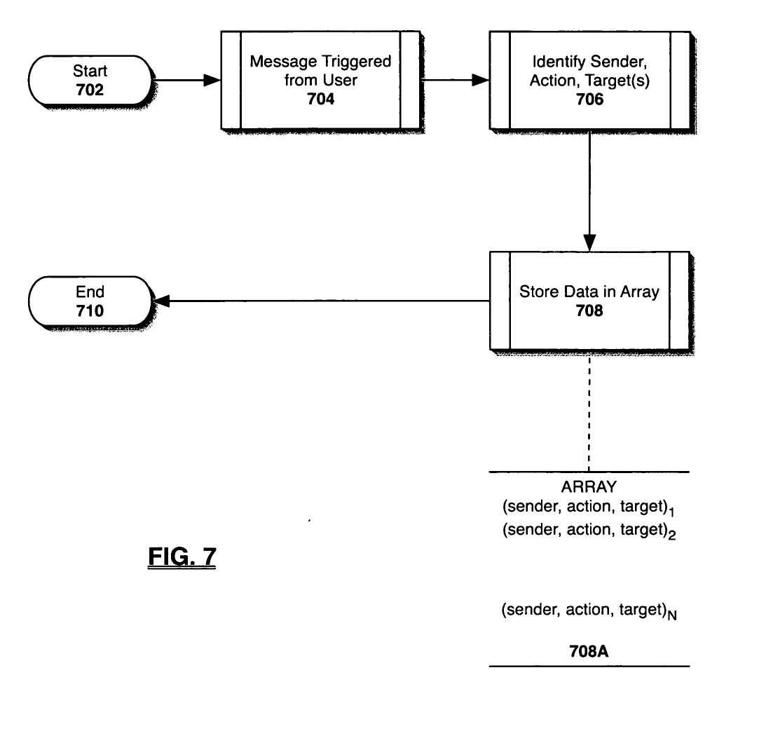

FIG. 7 is a flowchart illustrating the functionality of the listener 700 component associated with the present invention. The functionality of the listener 700 is started 702 when the message is triggered by the user 704. Then, the sender, action, target or targets data are identified 706. The sender, action, target or targets data is stored in a data array 708. An example of a data listing array 708A is illustrated. The sender is who; the action includes a position; and the target reflects the effect. The data 708A is processed and stored for later use. The listener 700 is the component which is always looking for new events triggered 704 by the user. When an event is identified, a message needs to be captured in order to interpret and determine the values which are being sent by the event trigger 704. These values 708A will vary from project to project, but they will typically contain, for example, a set of targets, a set of coordinates, the rotation values or the distance from the center of the scene.

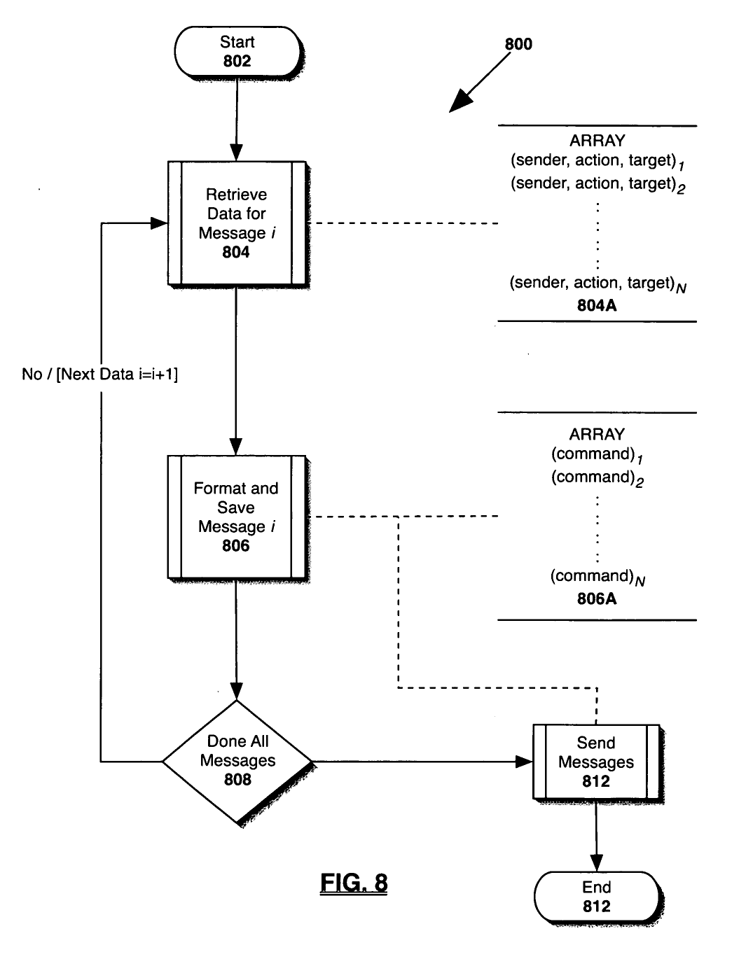

FIG. 8 is a flowchart illustrating the functionality of the processor 800 component associated with the present invention. The processor 800 starts 802 its functionality when the processor 800 receives data for a message 804, for example, messages. A data array 804A was created by the listener 700 as illustrated in FIG. 7. The processor 800 accesses the array information or data 804A for the particular message being processed. Typical array information or data 804A may comprise sender, action and target information. The message 804 is formatted and saved in a new array in the form of the commands 806A corresponding to each respective message 804A. The processor 800 determines if all messages have been processed, and if not, then the processor routine 800 is repeated beginning with retrieving data for the particular message in question 804. If all messages have been processed, then the messages are sent 810 to the target animation and the processing ends 812. Generally, the processor takes all the values which were identified by the listener 804, and starts creating individual messages 806 which will be relayed to each target 810. These messages 806 will contain a command or instruction 806A for use by the target animation. The command 806A is composed of all the information required to create an effect on the animations, either by moving it, rotating it, changing the zoom level or executing a specific action.

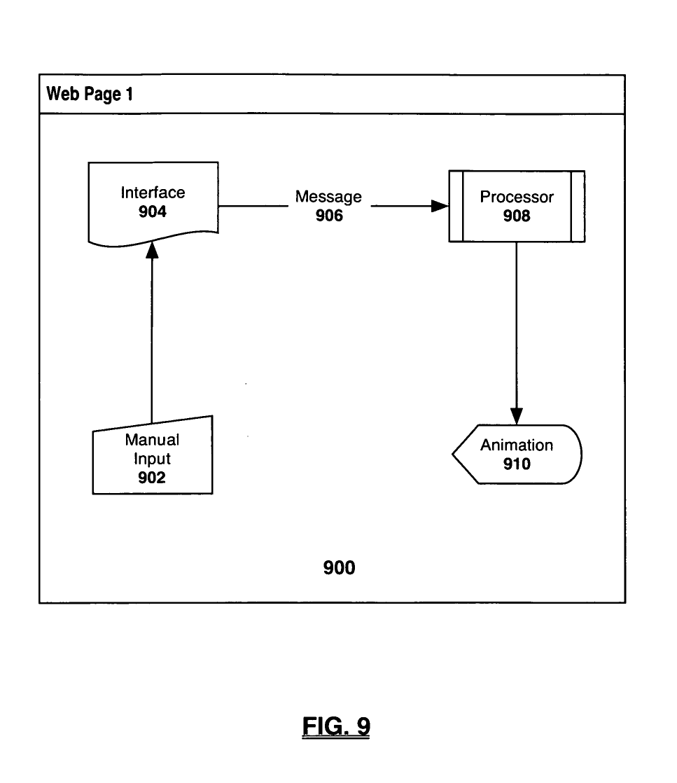

FIG. 9 is a flowchart of a method 900 of the present invention illustrating the manipulation of one or more objects in a set of animations through a user interface 904 associated with the present invention. For the scenario illustrated in FIG. 9, the user interacts directly with the interface 904 in order to create visual feedbacks within the animations, thereby allowing the manipulation of individual objects. Elements on the interface will manipulate different objects and may have different effects on such objects. Examples, without limitation, of different effects on the objects are movement, rotation, etc.

FIG. 9 illustrates the flow of the method 900 associated with the embodiment of the present invention for the manipulation of one or more objects in a set of animations through a user interface 900. The user interacts with the interface 900 by clicking a button or link 902. A message 906 containing a command is created. The created message 906 is sent to a processor 908 for evaluation with respect to a target animation 910. The target animation 910 is altered to reflect any visual modifications corresponding to changes made when the user interacted with the interface 904.

### Operation

In a preferred embodiment, the present invention has been created specifically for three-dimensional animations designed for use with the VMP. In order to use the present invention, a series of requirements need to be met. It can be appreciated by those skilled in the art that the requirements may be different for different projects. For example, it may be required that the project has a specific configuration from a selection of variations and several key elements need to be programmed or implemented into the animations involved.

An overview of the process layout of the present invention is depicted in FIG. 5. And associated with FIG. 5 is a description of the relevant components and how the relevant components interact within the overall process. Also, a project needs to have the components illustrated in FIG. 6, including a set of animations 602, an optional interface 614, a listener 606 and a processor 610. Typically, these components are placed within one container web page as illustrated in FIGS. 2 and 3 or within a parent/child connection between two web pages as illustrated in FIG. 4.

A set of animations composed of at least two animations is required. Each animation is assigned a role within the project: source, target or both. At least one of the animations has to act as the source, but it may also act as a target when several source animations are specified as illustrated in FIG. 3. The rest of the animations may act as a target. Even though an animation can act as both a source and a target, during the interaction process the animation cannot be its own target.

There are several variations in the configuration of a project in practicing the present invention. The number of variations will depend on the requirements of each project. The variations may differ in the following characteristics:
The amount of source animations,
The amount of target animations, and
A single web page or a parent/child-type of web pages.

The amount or number of source animations involved will have an impact on the functionality of the listener process. See, FIG. 7. A source animation is defined as an animation which contains an interactor embedded into the XML code of the content of the player, such as the Viewpoint player. An interactor is a function or procedure which recognizes any input by the user. The input can be provided from the user input or by creating any changes on the content. This interactor is responsible for triggering an event or sending a message once the user does any defined action within the animation. These actions are defined based on the requirements of each project and may include any of the following: change of position, rotation, zoom.

Once the user has interacted with the animation and the action is registered in the XML interactor, a message is sent in Java Script, to the container web page. This message contains the information required by the listener and processor to synchronize additional animations.

An interface component is typically present in the container web page. The interface may not necessarily be used as a visual aid in representing any changes triggered by the user through a source animation. In the case where the interface is used by the synchronization process, the information to generate any changes is sent through the triggered event in the source animation. Usually, the changes made to the interface are data related: showing measurements which reflect the current condition of the animation (i.e. distance, angles, position, active parts in the animation, etc.).

After the event has been triggered by the user's interaction with a source animation, the listener needs to process this event and determine which animation has initiated the message, what animations are being targeted, what action needs to be taken, what values need to be specified in order to take such actions. All this information is determined and stored in an array of values for later use.

This array of data needs to be read by a processor, which is the component that creates a series of messages, one message per targeted animation. These messages are customized to reflect each of the targeted animation's structure. For instance, if the user rotates a source animation on a left/right axis; this may be reflected in a similar rotation (left/right) on one target animation, but it may be a (up/down) rotation in another target animation. The processor temporarily stores all the messages in an array and when all messages are formatted, the messages are sent to the recipient animations. On occasion, special calculations need to be done before the messages are formatted; these calculations can be used in order to determine the value of an attribute for a target animation.

There are two main communications established pursuant to this invention:
Source animation-to-container web page, and
Container web page-to-target animations.
   To establish the communication between the source animation and the container web page, an interactor component, as listed in Table 1, needs to be placed within the XML code of the source animation. The interactor calls the processor function defined within the Java Script of the container web page with examples listed in Table 2. The communication is enabled via the VMP, through the instance of the object created.

TABLE 1
Interactor

| | |
|---|---|
| 1 | <MTSInteractor Name=“myInteractor” NeverHandle=“1” > |
| 2 | <MTSHandle Event=“MouseDrag” Action=“MTSJavaScript” |
| | Func=“myProcessor( )” /> |
| 3 | </MTSInteractor> |

TABLE 2
Processor code

| | |
|---|---|
| 1 | <script> |
| 2 | function myProcessor( ) { |
| 3 | doSomething( ); |
| 4 | } |
| 5 | </script> |

The second form of communication, between the container web page and the target animation is done through the VMP instance object as illustrated in Table 3. By creating and executing a dynamic code as sent to the target animation (See, Table 4) through the VMP Markup language. These commands are executed immediately once they are received by the target animation.

TABLE 3
VMP instance object

| | |
|---|---|
| 1 | <script language=“javascript”> |
| 2 | vmp = new MTSPlugin(“heart/heartM.mtx”, “100%”, “100%”, |
| 3 | “BroadcastKey.mtx”, “classic”, “ContentType=1”); |
| 4 | </script> |
| 5 | |

TABLE 4
Sample code of commands to target animation

| | |
|---|---|
| 1 | function rotateCineCamera(newAlpha, newBeta) { |
| 2 | |
| 3 | timeLineVals = “[ 1 2 3 ] [ 4 5 6 ]”; |
| 4 | animName = myAnimation; |
| 5 | alpha = myAlpha; |
| 6 | beta = myBeta; |
| 7 | |
| 8 | target = MTSMarkup(“Target”, “”, “Name”, |
| 9 | “MTSInstance.camera”, “Property”, “rot_”, |
| | “Timeline”, “tl_rot_cineCam); |
| 10 | time = MTSMarkup(“Time”, timeInterval); |
| 11 | timeLine = MTSMarkup(“Timeline”, timeLineVals, “Name”, |
| 12 | “tl_rot_cineCam”+animName, “Type”, “3D”); |
| 13 | timeElement = MTSMarkup(“MTSTimeElem”, target + time + |
| 14 | timeLine, “Type”, “Keyframe”, “Name”, |
| | “rotateCineCamera”+animName, “On”, “0”); |
| 15 | |
| 16 | targetAnimation.Execute(timeElement); |
| 17 | } |

Throughout the process, information is gathered by the listener and created by the processor. In both cases, the information is stored on the client side, i.e., the user's browser, in different arrays which are shared between the functions. These arrays are managed and processed using Java Script.

There are different possibilities to layout or configure the components in order to achieve this synchronization effect. Some of the possibilities are one source with n-target animations, n-sources with n-target animations, and parent/child web pages.

The one source animation with n-target animations model is illustrated in FIG. 2. In this model, there will be one web page which will contain one source animation and one or several target animations. This is a basic design of the present invention. There is only one source animation, which means that the listener's function is simplified to receive requests from a single object. It is not required for the listener to spend computational time in identifying which animation has submitted the request or to exclude the source animation from any targeting effects by the processor. Once the messages have been captured and processed, commands are sent to at least the target animations.

The N-source animations with N-target animations model is illustrated in FIG. 3. In this model, there are several source animations with several target animations. In order for this model to work, the listener's function has been modified. It is required to determine which animation is sending the information. Once that has been determined, the listener continues with its standard functionality. It is necessary to determine which animation is sending the request, first, to know how to interpret any information coming from it; and second, to exclude it from any commands being targeted by the processor.

Source animations may vary in the way that information needs to be interpreted and what values need to be received by the listener. This adds a level of complexity to the listener process. The job of the processor is standard in the N-source animations with N-target animations model. No changes are required to accommodate the different sources. The main reason for this is that the listener has provided the information in a standard format that the processor recognizes.

The parent/child web pages communication model is illustrated in FIG. 4. This model considers a structure where a main web window, the parent window, and a secondary window, the child window, is created. The secondary window may be created automatically, or by user interaction (i.e., selecting an option, clicking a specific section of the three-dimensional animation, etc.). It is important that the secondary window be created as a child, and not just as an additional window. Unless it is a child window, communication will not be enabled between the separate windows.

FIG. 4 depicts a basic layout for the parent/child model providing one source animation and one target animation. But complexity can be added to the model by adding several source and several target animations, creating a similar model as FIG. 3.

Additional advantages and modification will readily occur to those skilled in the art. The invention in its broader aspects is therefore not limited to the specific details, representative apparatus, and the illustrative examples shown and described herein. Accordingly, the departures may be made from the details without departing from the spirit or scope of the disclosed general inventive concept.

What is claimed is:

1. The method of synchronizing and controlling a source animation with a target animation comprising the steps of:
(a) making a change in the source animation,
(b) evaluating the characteristics of the change via an interactor function for generating a change message,
(c) sending the change message associated with the change in the source animation for evaluation with respect to the existing state of the target animation,
(d) using the change message to determine the effects on the target animation because of the change in the source animation,
(e) calculating the changes to be made in the target animation, if any, based upon the change message,
(f) receiving the commands for evaluation to determine the changes, if any, on the target animation, and
(g) synchronizing and coordinating the target animation with the source animation.

2. A method of synchronizing and controlling a source animation with a plurality of target animations with all the animations on the same web page comprising the steps of:
(a) making a change in the source animation,
(b) evaluating the characteristics of the change via an interactor function for generating a change message,
(c) communicating the change in the source animation with a listener,
(d) capturing and determining the message parameters,
(e) transferring the captured message parameters to a processor,
(f) processing the captured message parameters,
(g) transferring the processed signals to the respective target animations, and
(h) altering as appropriate the target animations so as to synchronize and coordinate the changes made in the source animation with what is viewed in the target animations.

3. A method of synchronizing and controlling a source animation in association with a parent web page with a target animation in association with a child web page where the source animation is in operative association with the target animation, the method comprising the steps of:
(a) initiating a change in the source animation,
(b) evaluating the characteristics of the change via an interactor function for generating a change message,
(c) communicating the change in the source animation with a listener associated with the same web page,
(d) capturing and determining the message parameters,
(e) transferring the captured message parameters to a processor associated with the target web page,
(f) processing the captured message parameters,
(g) transferring the processed signals to the respective target animation, and
(h) altering as appropriate the target animation so as to synchronize and coordinate the changes made in the source animation with what is viewed in the target animation.

4. The method of synchronizing and controlling a source animation with a target animation comprising the steps of:
(a) maintaining source information in association with the source animation,
(b) changing the source animation when a user interacts with the source animation,
(c) executing an animation trigger when the user interacts with the source animation,
(d) sending an event message when the animation trigger is executed,
(e) receiving the sent event message by a listener that captures the message,
(f) determining the parameters of the massage,
(g) processing the message parameters,
(h) creating a command corresponding to the message parameters,
(j) sending the processed command to the target animation,
(i) processing the created command, and
(k) implementing the processed commands on the target animation to synchronize and coordinate the source animation with the target animation to accurately reflect the changes that were made in the source animation in the target animation for enhancing the proficiency and experience of the user.
